(19) United States
(12) Patent Application Publication
(10) Pub. No.: US 2016/0144755 A1
(43) Pub. Date: May 26, 2016

(54) SEAT CUSHION WITH RAPID COOLING AND HEATING FUNCTION

(71) Applicants: Hezhang Chen, Dongguan (CN); Guanyu Chen, Dongguan (CN); Shufang Cui, Dongguan (CN)

(72) Inventors: Hezhang Chen, Dongguan (CN); Guanyu Chen, Dongguan (CN); Shufang Cui, Dongguan (CN)

(21) Appl. No.: 14/903,670

(22) PCT Filed: Dec. 3, 2013
(86) PCT No.: PCT/CN2013/088418

§ 371 Date: Jan. 8, 2016

(30) Foreign Application Priority Data
Dec. 4, 2012 (CN) 201210512609.8
Apr. 28, 2013 (CN) 201310156244.4

(51) Int. Cl. B60N 2/56

(52) U.S. Cl. CPC B60N 2/5628

(57) ABSTRACT

A seat cushion with a rapid cooling and heating function comprises a hollow cushion body (1). The hollow cushion body (1) is provided with an air-inlet hole (11) and made of a breathable material. The air-inlet hole (11) is connected with a gas-guide tube (2), and a front end of the gas-guide tube (2) is provided with a seal cover (3). The seal cover (3) is formed by a conical spring (31) and an outer cover cloth (33), and a first clamp (35) is fixed to an end of the conical spring (31). The hollow cushion body (1) is internally provided with an atmolysis device (4), the atmolysis device (4) is formed by an atmolysis block (41) and a group of atmolysis pipes (43), air-outlet ends of the group of atmolysis pipes (43) are respectively arranged in each area of the hollow cushion body (1).

### FIELD OF THE INVENTION

The present invention relates to a variable-temperature seat cushion, more particularly to a variable-temperature car seat cushion.

### BACKGROUND OF THE INVENTION

In summer, when a car is parked in sun, it will become hot and stuffy, and the people on the seat thereof will feel intolerable hot. You may have to wait a very long time after starting, and still loathly get into the car, which wastes time and increases energy consumption. Therefore, many methods for cooling the seat cushion are provided, for example, the seat cushion is made of white color or other light colors materials, or is made of flax, ice silk, silk, bamboo, green leather and other cool materials. However, the cooling effect is unsatisfactory according to feedbacks from users.

Further, some seat cushions are improved to have variable-temperature function. One type is to improve the structure thereof, such as setting a refrigeration system or a small fan in the seat cushion. The disadvantages of this type are: the internal structure of the seat cushion is very complex, which increases production costs; additionally, large volume and rigid body thereof may affect aesthetics and comfort, and also be easy to be damaged. Another type is to connect the seat cushion with the refrigeration system of the car, the disadvantages thereof are: the refrigeration system of the car should be transformed for this seat cushion, which is very troublesome; additionally, this seat cushion are provided with inlet and outlet, cold air can not remain therein because it overflows from the outlet after just entering therein, which will reduce the cooling effect.

A Chinese utility model patent (CN202264670U) discloses a multilayer breathable car seat cushion connecting with an air conditioning vent in the car so as to send cool air from the air condition into the seat cushion, thereby cooling the seat cushion. This seat cushion has solved the problem of rapid cooling, but there are also some obvious flaws. Specifically: first, gas-guide tubes being provided with many ventilation holes will cause uneven cold and heat distribution in the seat cushion, because cold air from the air condition will firstly overflow from the nearer ventilation holes, so that, the closer the area is to the inlet, the more cold air it will get, that is, because of the ventilation holes, the areas that are far away from the inlet may get little cold air, thereby leading to uneven cold and heat distribution in the seat cushion. Secondly, the irrational distribution of the gas-guide tubes may affect the cooling speed and effect, and increase costs. Small volume of the clod air from the car air condition plus excessive gas-guide tubes densely covering every area may reduce the cooling speed, and excessive gas-guide tubes also increase the production cost. Thirdly, it does not disclose a method for connecting the seat cushion with the air conditioning vent, as the car air conditioning vent can not be connected with gas-guide tubes, so how to connect the air conditioning vent with the seat cushion is also a serious problem. Therefore, it is necessary to provide a seat cushion having uniform temperature and rapid cooling speed, and being convenient to connect with the air conditioning vent.

### SUMMARY OF THE INVENTION

One objective of the present invention is to provide a seat cushion, which has a rapid cooling and heating function and uniform temperature, is convenient to use, and meets the environmental protection and energy saving requirements.

To achieve the above objective, a seat cushion with a rapid cooling and heating function includes a hollow cushion body, the hollow cushion body is provided with an air-inlet hole and made of breathable material, the air-inlet hole is connected with a gas-guide tube, and a front end of the gas-guide tube is provided with a seal cover.

Preferably, a magnet is configured in the seal cover.

Preferably, the seal cover is formed by a conical spring and an outer cover cloth, and a first clamp is fixed to an end of the conical spring.

Preferably, the seal cover is a conical crumpled sucker and the inner wall thereof is fixed with a second clamp.

Preferably, the hollow cushion body is internally provided with an atmolysis device, the atmolysis device is formed by an atmolysis block and a group of atmolysis pipes, the atomolysis block has a group of atmolysis holes, the group of atmolysis pipes comprises a first pipe, a second pipe, a third pipe, a forth pipe, and a fifth pipe, the atomolysis block is connected to the air-inlet hole of the hollow cushion body, and the group of the atmolysis holes is correspondingly connected to air-inlet ends of the group of the atomolysis pipes,

Preferably, the length of the first pipe, the second pipe, the third pipe, the forth pipe, and the fifth pipe of the group of atmolysis pipes are decreasing in sequence, and air-outlet ends of the group of atmolysis pipes are respectively arranged in each area of the hollow cushion body.

Preferably, the air-outlet ends of the group of atmolysis pipes are air exhausting nozzles.

Preferably, the group of atmolysis pipes is fixed in a cavity of the hollow cushion body.

Preferably, the gas-guide tube is a crumpled hose.

Compared with the prior art, the advantages of the present invention are: (1) reasonable structure, rapid cooling speed; a group of atmolysis pipes of different lengths uniformly arranged can rapidly send cold (heat) air to each key area contacting with the body, thereby achieving rapid cooling (heating) effect; (2) Uniform temperature; the number of the atmolysis pipes is proper, and these parallel atmolysis pipes can effectively send cold (heat) air to each area without uneven cold and heat distribution. (3) Convenient to use, simple to operate; a seal cover is configured to facilitate rapid connection of the seat cushion and air conditioning vent. (4) Environmental protection and energy saving, high comfort; rapid cooling (heating) speed can reduce the working hours of air condition; the cold (heat) air from the air condition enters into the seat cushion and then overflows therefrom, thus the cold (heat) air can remain longer time in the vicinity of the human body, even the air condition is adjusted to a same temperature as the prior art, this seat cushion of the present invention can give users a more cold (warm) feeling.

### BRIEF DESCRIPTION OF THE DRAWINGS

The accompanying drawings facilitate an understanding of the various embodiments of this invention. In such drawings:

FIG. 1 is a schematic view of a seat cushion with a rapid cooling and heating function according to one embodiment of the present invention;

FIG. 2 is a schematic view of the seat cushion with a rapid cooling and heating function of FIG. 1 showing the inner structure;

FIG. 3 is a schematic view of an atmolysis device of the seat cushion with a rapid cooling and heating function;

FIG. 4 is a schematic view of the seat cushion with a rapid cooling and heating function in use; and

FIG. 5 is a schematic view of a seat cushion with a rapid cooling and heating function according to second embodiment of the present invention, the seal cover thereof is a crumpled sucker.

### DETAILED DESCRIPTION OF ILLUSTRATED EMBODIMENTS

### Embodiment 1

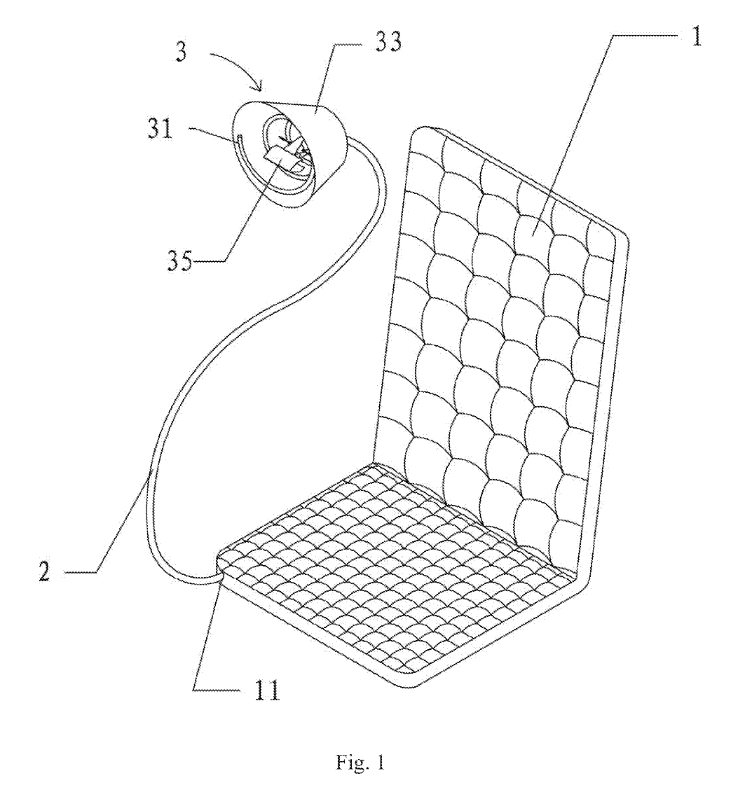

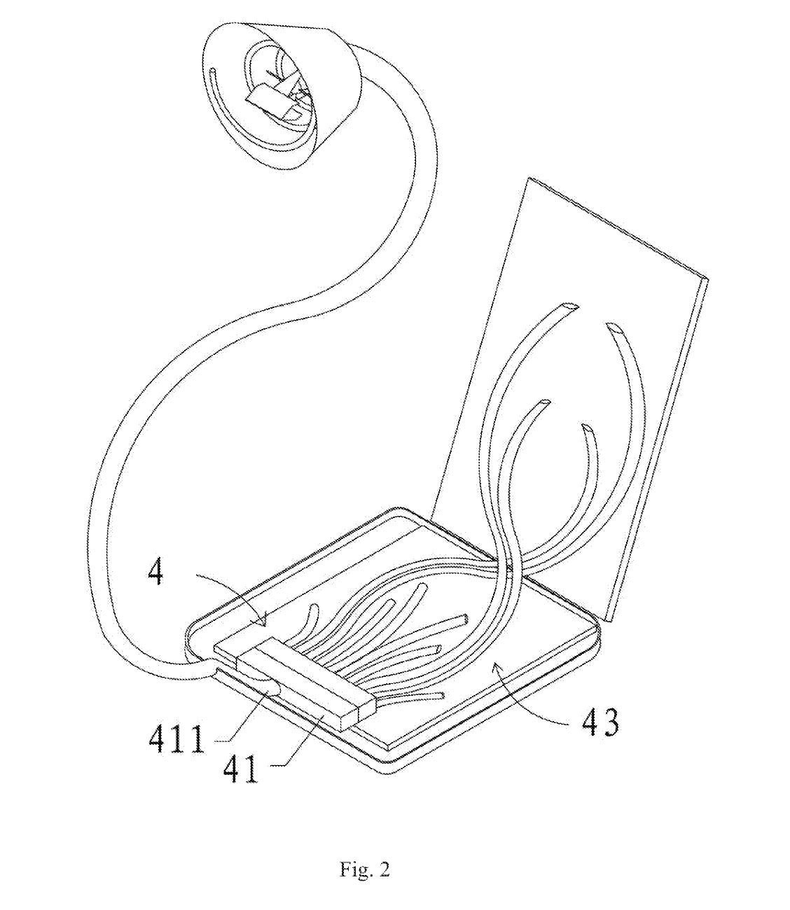

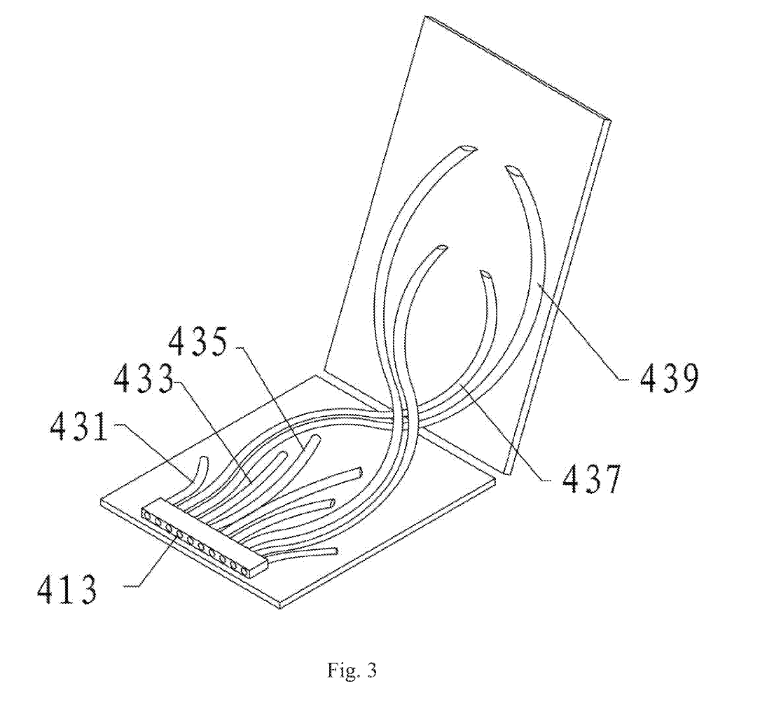

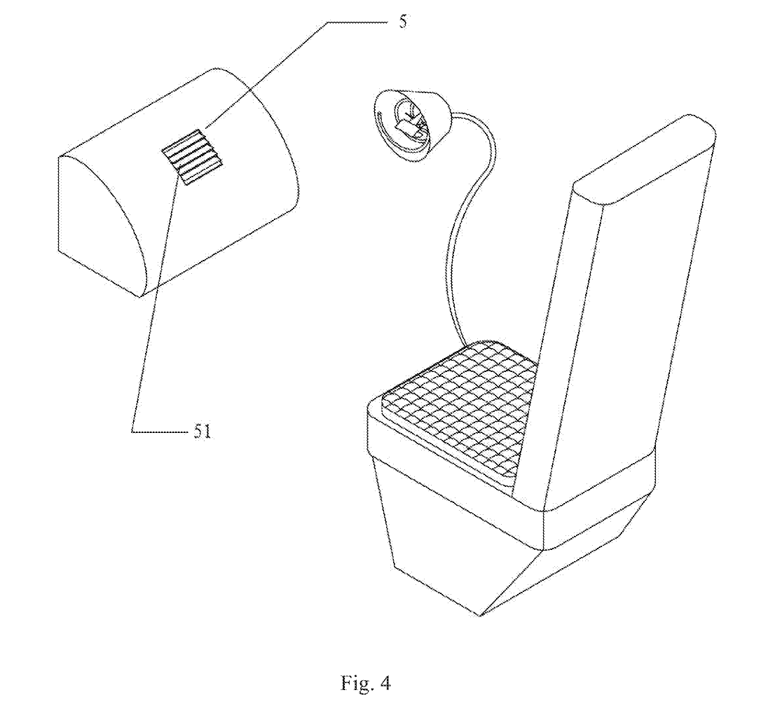

As illustrated in FIGS. 1 to 4, a seat cushion with a rapid cooling and heating function includes a hollow cushion body 1, the hollow cushion body 1 is provided with an air-inlet hole 11 and made of breathable material, The air-inlet hole 11 is connected with a gas-guide tube 2, and a front end of the gas-guide tube 2 is provided with a seal cover 3. This seat cushion can be connected with air conditioning vent 5 of car and so on, the seal cover 3 covers the air conditioning vent 5 so as to send air from the air condition to the cavity of the hollow cushion body 1 through gas-guide tube 2. The hollow cushion body 1 is only provided with air-inlet hole 11, but without air-outlet hole, because the hollow cushion body 1 is made of breathable material so that air therein can overflows, the breathable material can be cloth and so on.

Preferably, the seal cover 3 is formed by a conical spring 31 and an outer cover cloth 33. A first clamp 35 is fixed to an end of the conical spring 31, Generally, fixing the pin of torsion spring of the first clamp 35 to the end of the conical spring 31, and the first clamp 35 matches with the louver of the air conditioning vent 5.

Preferably, the hollow cushion body 1 is internally provided with an atmolysis device 4, the atmolysis device 4 is formed by an atmolysis block 41 and a group of atmolysis pipes 43, the atomolysis block 41 has a group of atmolysis holes 413, the group of atmolysis pipes 43 includes a first pipe 431, a second pipe 433, a third pipe 435, a fourth pipe 437, and a fifth pipe 439. The atomolysis block 41 is connected to the air-inlet hole 11 of the hollow cushion body 1, and the group of the atmolysis holes 413 is correspondingly connected to air-inlet ends of the group of the atomolysis pipes 43. The atomolysis block 41 can uniformly distribute air flow into each of the group of atmolysis pipes 43 so as to avoid uneven cold and heat distribution. The atomolysis block 41 can be provided with a cavity and a gas pipe 411, the air flow enters in the cavity of the atomolysis block 41 through the gas pipe 411, and then enters into each of the group of atmolysis pipes 43 through each atmolysis hole 413. Of course, the atomolysis block 41 also can be only provided with a group of atmolysis hole 413, and directly connected with air-inlet hole 11 of the hollow cushion body 1 through pipe.

Preferably, the length of the first pipe 431, the second pipe 433, the third pipe 435, the forth pipe 437, and the fifth pipe 439 of the group of atmolysis pipes 43 are decreasing in sequence, and air-outlet ends of the group of atmolysis pipes 43 are respectively arranged in each area of the hollow cushion body 1. As the air flow from the air conditioning vent 5 is limited, so it is necessary to send the limited cool air to several key areas so as to achieve rapid cooling effect, that is, the “each area” means the area contacting the user, rather than uniform distribution.

Preferably, the air-outlet ends of the group of atmolysis pipes 43 are air exhausting nozzles. The air exhausting nozzle can longitudinally divide the pipe wall of the air-outlet end of atmolysis pipe 43 into several pieces, or can be beveled nozzle, as long as it allows air flow to be rapidly sent to each area, so as to achieve rapid cooling effect.

Preferably, the group of atmolysis pipes 43 is fixed in a cavity of the hollow cushion body 1. can be fixed by adhesive tape, or be sewn on a bottom of the seat cushion with strips of cloth, so as to prevent the atmolysis pipes 43 from moving.

Preferably, the gas-guide tube 2 is a crumpled hose. This gas-guide tube 2 can be placed in any position, and will not affect the driver's work.

When using this rapid variable-temperature seat cushion, open first clamp 35 of the seal cover 3 to clamp the deflector 51 of air conditioning vent 5. At the same time the conical spring 31 is compressed, and the seal cover 3 is pressed against the air conditioning vent 5 to guide cold air enter into the cavity of the hollow cushion body 1 through gas-guide tube 2, thereby cooling the seat cushion.

When you do not need it, removing the first clamp 35, and the seal cover 3 is separated from the air conditioning vent 5 under the action of the conical spring 31 Then the rapid variable-temperature seat cushion can be used as an ordinary seat cushion.

### Embodiment 2

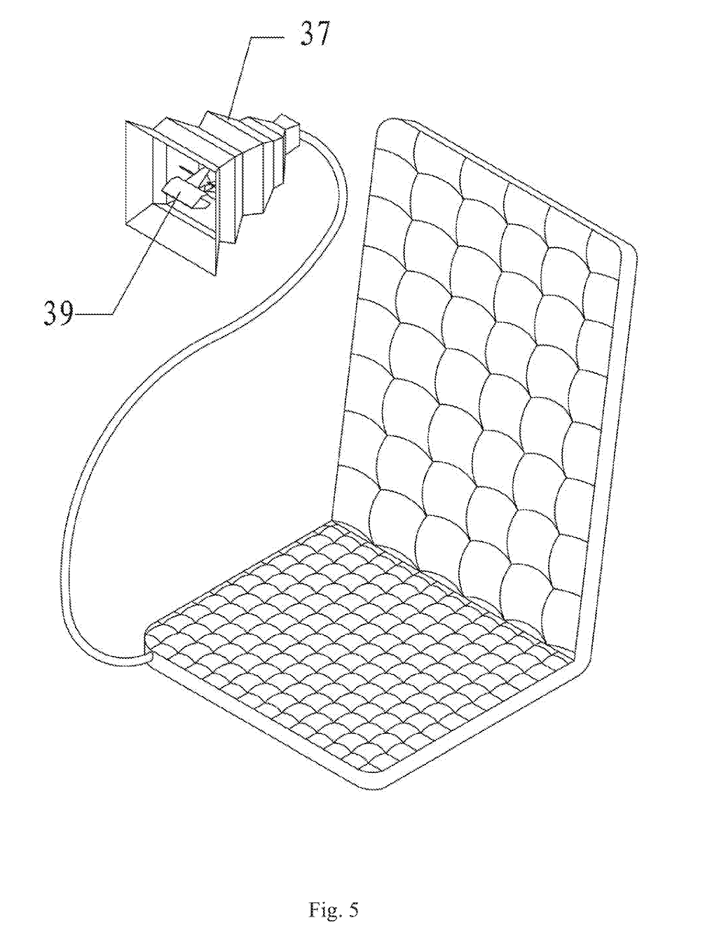

The seal cover 3 can also be improved based on embodiment 1. As shown in FIG. 5, the seal cover 3 is a conical crumpled sucker 37 and the inner wall thereof is fixed with a second clamp 39. The conical crumpled sucker 37 has elasticity, it can be adsorbed on air conditioning vent 5 when in use. This type of seal cover 3 can also send cold air from air condition to the hollow cushion body 1.

The operation process is the same as the embodiment 1, and the technical features of the embodiment 1 also can be applied in embodiment 2, so I won't repeat it now.

In addition, the seal cover 3 can be provided with a magnet therein, accordingly the air conditioning vent 5 is also provided with another magnet, which can achieve the same effect.

This seat cushion with a rapid cooling and heating function significantly reduces the waiting time of the users, provides drivers with a more comfort feeling, and the drivers can concentrate mind to drive, thereby improving driving safety. Additionally, this seat cushion with a rapid cooling and heating function is not limited to cooling, when the air flow from the air condition is warm in winter, it can be rapidly heated. This seat cushion is particularly suitable for a car without seat heating function. Of course, such this seat cushion with a rapid cooling and heating function can be used in car as well at home and other places.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A seat cushion with a rapid cooling and heating function, comprising a hollow cushion body, the hollow cushion body being provided with an air-inlet hole and made of breathable material, the air-inlet hole being connected with a gas-guide tube, and a front end of the gas-guide tube being provided with a seal cover.

2. The seat cushion with a rapid cooling and heating function according to claim 1, wherein a magnet is configured in the seal cover.

3. The seat cushion with a rapid cooling and heating function according to claim 1, wherein the seal cover is formed by a conical spring and an outer cover cloth, and a first clamp is fixed to an end of the conical spring.

4. The seat cushion with a rapid cooling and heating function according to claim 1, wherein the seal cover is a conical crumpled sucker and the inner wall thereof is fixed with a second clamp.

5. The seat cushion with a rapid cooling and heating function according to claim 1, wherein the hollow cushion body is internally provided with an atmolysis device, the atmolysis device is formed by an atmolysis block and a group of atmolysis pipes, the atomolysis block has a group of atmolysis holes, the group of atmolysis pipes comprises a first pipe, a second pipe, a third pipe, a forth pipe, and a fifth pipe, the atomolysis block is connected to the air-inlet hole of the hollow cushion body, and the group of the atmolysis holes is correspondingly connected to air-inlet ends of the group of the atomolysis pipes.

6. The seat cushion with a rapid cooling and heating function according to claim 5, wherein the length of the first pipe, the second pipe, the third pipe, the forth pipe, and the fifth pipe of the group of atmolysis pipes are decreasing in sequence, and air-outlet ends of the group of atmolysis pipes are respectively arranged in each area of the hollow cushion body.

7. The seat cushion with a rapid cooling and heating function according to claim 6, wherein the air-outlet ends of the group of atmolysis pipes are air exhausting nozzles.

8. The seat cushion with a rapid cooling and heating function according to claim 7, wherein the group of atmolysis pipes is fixed in a cavity of the hollow cushion body.

9. The seat cushion with a rapid cooling and heating function according to claim 8, wherein the gas-guide tube is a crumpled hose.
